(19) United States
(12) Patent Application Publication
(10) Pub. No.: US 2026/0363162 A1
(43) Pub. Date: Nov. 19, 2026

(54) SEED METER HOUSING FOR HIGH SPEED PLANTING IMPLEMENT

(71) Applicant: Kinze Manufacturing, Inc., Williamsburg, IA (US)

(72) Inventors: Collin Jones, Williamsburg, IA (US); Matthew Wilhelmi, Williamsburg, IA (US); Chris McElvain, Williamsburg, IA (US)

(21) Appl. No.: 19/677,080

(22) Filed: May 14, 2026

Related U.S. Application Data
(60) Provisional application No. 63/805,616, filed on May 14, 2025.

(51) Int. Cl. A01C 7/12; A01C 7/04

(52) U.S. Cl. CPC A01C 7/123; A01C 7/0443; A01C 7/046

(57) ABSTRACT

An agricultural planting implement includes a number of row units. The row units include one or more seed meters for receiving, singulating, and dispensing seed to the ground such that preferred spacing of subsequent seed is attained. The seed meter may be an air pressure meter that utilizes positive or negative pressure within the meter housing to aid in holding seed at seed cells of a seed disc within the meter housing. To aid in efficiency for the air pressure, the seed meter housing can include channels and/or other air directing elements to direct the air in places where pressure differential is needed, which can reduce the overall pressure needed for an implement.

### CROSS REFERENCE TO RELATED APPLICATIONS

This application claims priority under 35 U.S.C. § 119(e) to provisional patent application U.S. Serial No. 63/805,616, filed May 14, 2025. The provisional patent application is hereby incorporated by reference in its entirety herein, including without limitation: the specification, claims, and abstract, as well as any figures, tables, appendices, or drawings thereof.

### TECHNICAL FIELD

The present invention relates generally to agricultural implements. More particularly, but not exclusively, the invention relates to an agricultural planter with a seed delivery apparatus for delivering seed from a metering system of a row unit to a furrow created in the ground.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

An agricultural row crop planter is a machine built for distributing seed into the ground. The row crop planter generally includes a horizontal toolbar fixed to a hitch assembly for towing behind a tractor. Row units are mounted to the toolbar. In different configurations, seed may be stored at individual hoppers on each row unit, or it may be maintained in a central hopper and delivered to the row units on an as needed basis. The row units include ground-working tools for opening and closing a seed furrow, and a seed metering system for distributing seed to the seed furrow.

In its most basic form, the seed meter includes a housing and a seed disc. The housing is constructed such that it creates a reservoir to hold a seed pool. The seed disc resides within the housing and rotates about a generally horizontal central axis. As the seed disc rotates, it passes through the seed pool where it picks up individual seeds. The seeds are subsequently dispensed from the seed meter and transported to the seed furrow.

Seed spacing in the seed furrow is roughly controlled by varying the rotational speed of the seed disc. The most common seed delivery system for delivering seed from the seed disc to the furrow may be categorized as a gravity drop system. In the case of the gravity drop system, a seed tube has an inlet end, which is positioned below the seed metering system. The singulated seeds from the seed metering system drop into the seed tube and fall via gravitational force from a discharge end thereof into the seed furrow. Monitoring systems are commonly used to monitor the operation of the planter. Such systems typically employ a seed sensor attached to each seed tube to detect the passage of seed therethrough.

However, such a gravity system can affect the seed spacing of the planter. For example, as the spacing of the speed is dependent on the rotational velocity of the seed disc and the gravitational constant, interruptions, forces, or other occurrences acting on the seed can greatly affect the spacing. For example, if the seed bumps against a wall of the seed tube on the way to the furrow; this can cause a delay or a non-vertical fall of the seed. If a preceding or following seed does not experience the same interruption, the seeds could be spaced too close or far from one another.

Furthermore, as the speed of planting increases, this causes additional problems. Drawing a planting implement through the field at faster speeds increases the speed of deposited seeds relative to the ground, causing seeds to roll and bounce upon landing in the trench or furrow and resulting in inconsistent plant spacing. The adverse agronomic effects of poor seed placement and inconsistent plant spacing are well known in the art.

Solutions have arisen to allow for planting at higher speeds (e.g., speeds over 8 miles per hour). For example, U.S. Patent No. 10,842,072, the figures and description of which being hereby incorporated by reference in their entirety, provides a solution for singulating seed and delivering it to the ground in a controlled manner, such as via a flighted belt in a housing. The flighted belt is driven to be moved (i.e., rotated) at a speed that corresponds to a ground speed of the implement such that seed that is distributed from the housing via the belt experiences a substantially zero horizontal velocity component, which mitigates bounce or roll of the seed in a furrow. This controlled delivery allows for planting at speed higher than 8-10 miles per hour, while also improving upon the placement of seeds at lower speeds as well.

However, one issue with planting at higher speeds is that the seed meter and other components rotate at a higher speed and the confidence in seeds being held, such as via vacuum or positive pressure, at the seed disc is needed. Thus, to ensure seeds at each cell of the disc, a higher than needed pressure is applied across the disc to create a pressure differential at the seed cells. This requires greater energy input to ensure that a lowest needed pressure be achieved during the planting process. While this has proved to work, it is desirable to lower the energy needs for applying the pressure differential at the seed cells to achieve the same or better singulation and planting rates, while utilizing less overall energy by the planting implement.

Thus, there exists a need in the art for a system, apparatus, and/or method which allows for planting seeds at high speeds while reducing the needed energy to achieve the highest possible rates of planting.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any of the aspects and/or embodiments of the present disclosure to improve on or overcome the deficiencies in the art.

It is a further object, feature, and/or advantage of any of the aspects and/or embodiments of the present disclosure to improve on efficiencies of seed meters used for high volume and/or high speed planting. For example, high volume and/or high speed planting may require additional pressure in or at the seed meter, and aspects of the disclosure improve efficiencies for applying such pressures (positive or negative pressures).

It is still yet a further object, feature, and/or advantage of any of the aspects and/or embodiments of the present disclosure to provide for laminar flow of a fluid, such as air, at or near one or more portions of the interior of a seed meter housing to aid in improving efficient use of such fluid.

It is another object, feature, and/or advantage of any of the aspects and/or embodiments of the present disclosure to be compatible with different seed to ground delivery types, including controlled delivery and gravity style seed tubes.

The systems and apparatus disclosed herein can be used in a wide variety of applications. For example, while the systems will be related to agricultural planting implements, it should be appreciated that these can include a number of applications, including a number of seed or other particulate material types for application to a field.

It is preferred the apparatus be safe, cost effective, and durable. For example, the apparatus can be adapted to resist excessive heat, static buildup, corrosion, and/or mechanical failures (e.g. cracking, crumbling, shearing, creeping) due to excessive impacts and/or prolonged exposure to tensile and/or compressive forces acting on the apparatus.

According to some aspects of the present disclosure, a seed meter for an agricultural planting implement comprises a seed meter housing comprising a seed side member and an air pressure side member; wherein the air pressure side member comprises: an air pressure inlet; and an air pressure compartment in fluid communication with the air pressure inlet and including a wall separating the air pressure compartment from an interior of the seed meter housing, wherein the wall comprises at least one cutout through the wall to direct an air pressure into the interior of the seed meter housing.

According to at least some embodiments of the disclosure, the wall of the air pressure compartment comprises two cutouts.

According to at least some embodiments of the disclosure, a first cutout in the wall of the air pressure compartment is located at or near a seed pool location of the seed side member.

According to at least some embodiments of the disclosure, a second cutout in the wall of the air pressure compartment is located at or near a singulator of the seed meter housing.

According to at least some embodiments of the disclosure, the air pressure side member of the seed meter housing comprises a first portion comprising the wall separating the interior of the seed meter housing and a second portion covering the wall to create the air pressure compartment.

According to at least some embodiments of the disclosure, the second portion comprises the air pressure inlet.

According to at least some embodiments of the disclosure, the first and second portions are removably connected from one another.

According to at least some embodiments of the disclosure, the first portion comprises an electrical motor inlet for allowing a portion of an electric motor to extend into the interior of the seed meter housing to drive a seed disc therein.

According to at least some embodiments of the disclosure, the seed meter comprises a seed disc rotatably mounted in the interior of the seed meter housing, and the air pressure configured to act fully on a side of the seed disc.

According to additional aspects of the disclosure, a method of providing an air pressure to a seed meter of an agricultural planting implement comprises directing an air pressure through an inlet of an air pressure side member of the seed meter and into an air pressure compartment formed by a wall separating the air pressure compartment from an interior of the seed meter housing; directing, via one or more cutouts in the wall separating the air pressure compartment from the interior, the air pressure first to one or more areas in the seed meter before allowing the air pressure to continue to the remaining area in the interior of the seed meter.

According to at least some embodiments of the disclosure, the one or more cutouts comprises a first cutout at or near a seed pooling area in the seed meter.

According to at least some embodiments of the disclosure, the one or more cutouts comprises a second cutout at or near a singulator within the seed meter.

According to at least some embodiments of the disclosure, the air pressure is a negative pressure.

According to at least some embodiments of the disclosure, the air pressure is applied at a plurality of seed cells of a seed disc to hold seed at the seed cells.

According to at least some embodiments of the disclosure, the air pressure compartment is formed from the wall and an exterior portion of a cover positioned at the air pressure side member.

According to additional aspects of the disclosure, a seed meter for use with an agricultural implement comprises a seed meter housing comprising a seed side member and an air pressure side member; wherein the air pressure side member comprises: an air pressure inlet; and an air pressure compartment in fluid communication with the air pressure inlet and including a wall separating the air pressure compartment from an interior of the seed meter housing, wherein the wall comprises at least one cutout through the wall to direct an air pressure into the interior of the seed meter housing; and a seed disc rotatably mounted in the seed meter housing, the seed meter comprising a plurality of radially spaced seed cells, with the air pressure directed to the seed cells to create a pressure differential to hold seed at the cells.

According to at least some embodiments of the disclosure, the seed meter comprises a seed singulator positioned within the seed meter housing to interact with seed at the seed cells.

According to at least some embodiments of the disclosure, the wall of the air pressure compartment comprises two cutouts.

According to at least some embodiments of the disclosure, a first cutout in the wall of the air pressure compartment is located at or near a seed pool location of the seed side member.

According to at least some embodiments of the disclosure, a second cutout in the wall of the air pressure compartment is located at or near a singulator of the seed meter housing.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a perspective view of an agricultural planting implement.

FIG. 2 is a perspective view of a row unit for use with an agricultural planting implement, such as that shown in FIG. 1.

FIG. 3 is a perspective view of a seed meter and seed to ground delivery system

FIG. 4 is a perspective view of a seed meter according to aspects of the disclosure.

FIG. 5 is an exploded view of the seed meter of FIG. 4.

FIG. 6 is a perspective view of another seed meter according to aspects of the disclosure.

FIG. 7 is a perspective view of yet another seed meter according to aspects of the disclosure.

FIG. 8 is a perspective view of a seed side cover of the seed meter of FIG. 4.

FIG. 9 is a front elevation view of the seed side cover.

FIG. 10 is left elevation view of the seed side cover.

FIG. 11 is a rear elevation view of the seed side cover.

FIG. 12 is a right elevation view of the seed side cover.

FIG. 13 is a top plan view of the seed side cover.

FIG. 14 is a sectional view of the seed side cover according to line A-A of FIG. 11.

FIG. 15 is a partial sectional view of the seed side cover along line B-B of FIG. 9.

FIG. 16 is a partial sectional view of the seed side cover along line C-C of FIG. 9.

FIG. 17 is a partial sectional view of the seed side cover along line D-D of FIG. 9.

FIG. 18 is a partial sectional view of the seed side cover along line E-E of FIG. 9.

FIG. 19 is a perspective view of a portion of the pressure side cover of the seed meter of FIG. 4.

FIG. 20 is a front elevation view of the portion of the pressure side cover.

FIG. 21 is a left elevation view of the portion of the pressure side cover.

FIG. 22 is a rear elevation view of the portion of the pressure side cover.

FIG. 23 is an enlarged view of a portion of FIG. 20 noted by Detail A.

FIG. 24 is a partial sectional view taken along line B-B of FIG. 20.

FIG. 25 is a partial enlarged view of a portion of FIG. 22 noted by Detail C.

FIG. 26 is a sectional view of FIG. 22 taken along line D-D.

FIG. 27 is a perspective view of a pressure cover of the seed meter of FIG. 4.

FIG. 28 is a front elevation view of the pressure cover.

FIG. 29 is a side elevation view of the pressure cover.

FIG. 30 is a rear elevation view of the pressure cover.

FIG. 31 is a top plan view of the pressure cover.

FIG. 32 is a perspective view of a singulator assembly for use with a seed meter.

FIG. 33 is a front elevation view of the singulator assembly.

FIG. 34 is a bottom plan view of the singulator assembly.

FIG. 35 is a perspective view of a wire latch for use with seed meter housings according to aspects of the disclosure.

FIG. 36 is a front plan view of the wire latch.

FIG. 37 is a side view of the wire latch.

FIG. 38 is an enlarged, partial view of a portion of the wire latch according to line A-A of FIG. 36.

FIG. 39 is a front elevation view of an example of a seed disc and singulator.

FIG. 40 is a rear elevation view of the seed disc and singulator or FIG. 39.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “agricultural equipment” encompasses any type of machinery associated with the agriculture industry. For example, both agricultural vehicles and agricultural implements are encompassed by the term “agricultural equipment”.

The term “particulate material” shall be construed to have a broad meaning, and includes, but is not limited to grain, seed, fertilizer, insecticide, dust, pollen, rock, gravel, dirt, stock, or some combination thereof. Particulate material can be mixed with air to form airborne matter.

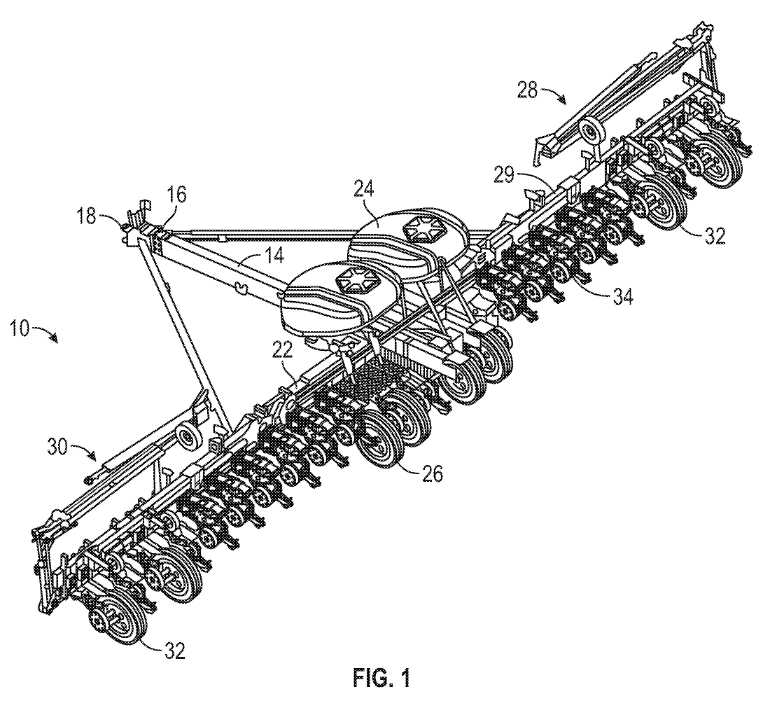

FIG. 1 shows an agricultural implement 10, in this case, an agricultural planter. The planter 10 is usually attached to and pulled by a tractor. However, it should be appreciated that other equipment and/or vehicles may move the implement 10. For purposes of the present disclosure, the implement 10 will be referred to as a planter. Planter may be self-contained and not be towed, such as an autonomous unit.

The planter 10 includes a tongue 14 having a first end 16 and an opposite second end (not shown). The tongue 14 includes a hitch 18 at the first end 16, with the hitch 18 being connected to the tractor. At the opposite end of the tongue 14 is a central tool bar 22. The tongue 14 may be a telescoping tongue with components capable of being inserted into one another such that the implement 10 is a front folding style implement. However, the present invention is not to be limited to such front folding style implements and is to include any such implement for use in the agricultural industry.

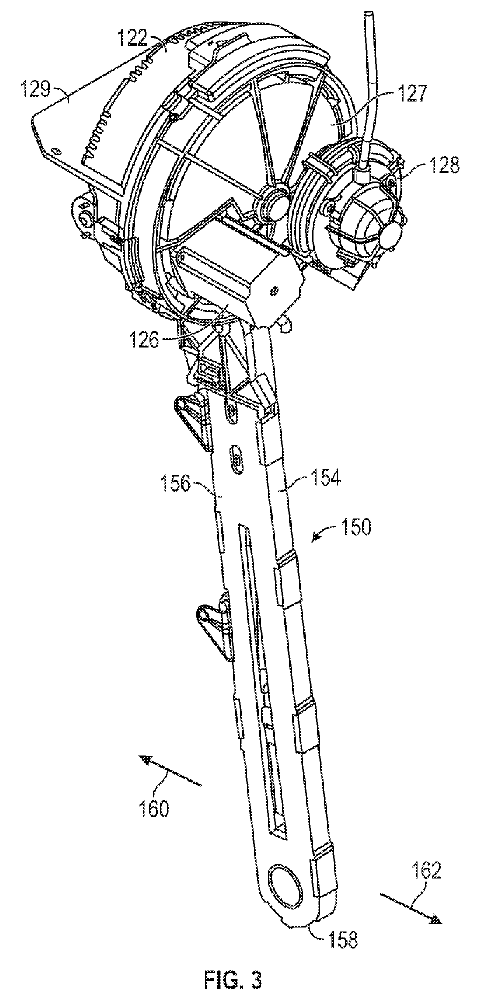

As shown in FIG. 1, central hoppers 24 are positioned at the central toolbar 22. The hoppers 24 are configured to store seed, fertilizer, insecticide, or other types of material for use in farming. The hoppers 24 may both contain the same material or could contain separate materials. The use of the central hoppers 24 allows for a large amount of material to be added and stored at a centralized location. However, the invention also contemplates the use of one or more hoppers positioned at each of the row units 34 for providing seed to be planted at the row units, as is shown in FIG. 3. When central hoppers 24 are used at the central toolbar 22, it should be appreciated that the central hoppers will be in fluid communication with each of the row units 34. This can be done by use of separate hoses to each of the row units, or fewer hoses that include splitters, wherein the hose is split to provide seed or other material to more than one row unit. Also connected to the central toolbar is a plurality of central wheels, which may be known as transport wheels 26 extending generally downwardly from the central toolbar 22. The wheels 26 contact the ground and support the central hoppers 24. The wheels stabilize the implement 10 and are the wheels that contact the ground when in a working position or a transport position, e.g., if the implement 10 is a front folding implement such that the wings 28, 30 are folded forward with wing wheels 32 not contacting the ground.

Extending generally from both sides of the toolbar 22 are first and second wings 28, 30. The wings 28, 30 are generally identical and mirror images of one another. Therefore, only one wing will be described with the understanding that the other wing will be generally the same configuration. The first wing 28 includes a bar 29. Mounted to the bar 29 are a plurality of row units 34, as well as a plurality of wheels 32. The wheels 32 are configured to contact the ground. The row units 34 may be seeders, fertilizers, insecticide sprayers, or other dispensers, discs, or plows. The wings 28, 30 may also include at least one fold cylinder and a down force cylinder. It is further contemplated that multiple down force cylinders be used with an implement having more sections. The fold cylinder(s) is configured to fold the wings to a position wherein the first and second wings 28, 30 are generally adjacent the tongue 14 of the implement 10.

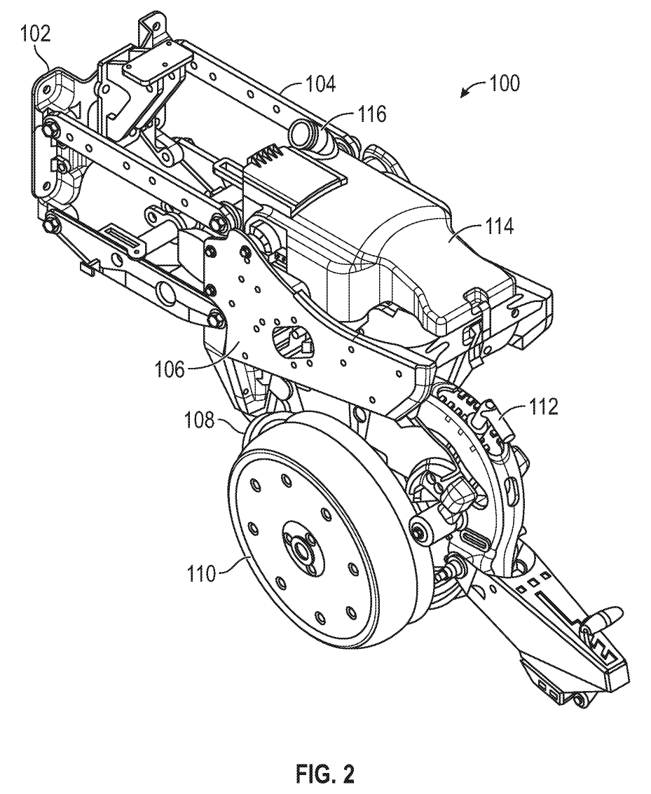

FIG. 2 discloses a row unit 100 according to and including aspects of the invention. The row unit 100 includes a plate 102 or other member for attaching the row unit 100 to a toolbar of a planting implement. Extending generally from the faceplate 102 is a linkage 104, which allows for some vertical movement of the row unit 100 relative to other row units and components of the planting implement. While not shown, a system, apparatus, and/or assembly for providing down and/or up force for the row unit may also be included for use with the row unit. Such a system is shown and described in U.S. Patent Application No. 16/047,236, which is hereby incorporated by reference in its entirety. A frame 106 is also included. The row unit 100 includes opening elements 108, which are in the form of opening or coulter wheels in the figures. Gage wheels 110, a depth adjustment system 112, and a sensor are included to adjust the depth of the furrow created and to sense and adjust an amount of supplemental down and/or up force for the row unit.

Connected to the frame 106 is a hopper attachment 114, which may also be referred to as a mini hopper. The attached 114 includes, in part, a lid portion, a receptacle portion, and a conduit attachment 116. The conduit attachment 116 can be attached, via delivery system, to one or more bulk hoppers of the planting implement to receive on-demand amounts of seed for the row unit. The seed can be stored, at least temporarily, at or in the attachment 114, where it can then be fed into a seed meter seed pool for singulation and delivery to the ground.

Additional aspects of a seed meter and/or seed delivery system are included in U.S. Patent No. 10,842,072, which is hereby incorporated by reference in its entirety. For example, as disclosed in the ‘072 patent, a seed meter will receive seed via the conduit and temporarily store the seed at a seed pool within a housing of the meter. A disc rotating within the housing will interact with the seed in the pool, and a pressure differential at seed apertures in and through the disc will cause the seed to adhere at the apertures of the disc. It is noted that the entire second side of the seed disc will be pressurized, and there will be no areas where the pressure difference is cut-off. The seed will travel on the disc until it is dislodged by a combination of a seed knock-off and a brush wheel, which are on opposites side of the seed disc, as will be disclosed herein. The seed will be transported via the brush wheel at a higher rotational velocity than the rotating speed of the disc to a point where the seed will be delivered towards a belt. The belt includes spaced flights, which will provide a controlled delivery towards a release point. The belt will have a velocity that is synced with the ground speed at the row unit such that the seed will be released from the belt and delivery system with a horizontal velocity component that is equal to said ground speed in an opposite direction so that the seed is release with zero relative velocity, which will mitigate bounce, roll, or other movement of the seed when it contacts the ground.

Therefore, the seed meter according to aspects and/or embodiments of the present disclosure, such as the seed meter 120 and seed to ground delivery system 150 shown in FIG. 3, may be similar to that shown and described in the ‘072 patent. As noted, the seed meter 120 includes a disc 200 within a housing 122. The housing 122 may be a one-piece or multi-component housing in which the components are attached to one another, such as by snapping together, clasping, of otherwise affixing temporarily or selectively to one another. For example, in some embodiments, the housing 122 may include a pressure side 127 and a seed side 129. The pressure side 127 can include a connection for a pressure source, such as a vacuum, fan, blower, or the like. In the embodiments shown, the pressure source is a dedicated or otherwise integrated fan 128 that is positioned on the housing 128. The integration of the fan 128 at the seed meter provide numerous advantages, such as individual control for each seed meter of each row unit, greater efficiency, reduction of hoses/conduits for the planter, etc. Additional advantages and description of integrating a fan 128 to the meter housing 122 are shown and described in U.S. Patent No. 9,763,380, which is hereby incorporated by reference in its entirety. The fan 128 can include a rotating member rotating at a high speed to create a pressure differential at the seed meter and can convey the pressure to within the housing via a cutout, aperture, conduit, or the like. The fan 128 can be electrically connected to a source that provides electric power thereto in order to operate. Additionally, the fan can be connected to a processing unit, central processor, or other computing member to provide commands and/or control of the fan at each of the seed meters at each of the row units. Still further, it should be appreciated that a pressure source, such as a hydraulic fan or the like could be positioned along the implement, such as at a toolbar to provide pressure for more than one row unit at a given time.

Also shown at the pressure side of the housing 122 is an electric motor 126. The motor 126 is used to provide rotational power to the seed disc 200 inside the housing. The electric motor 126 will also be connected to the central processor/control to provide a rotational velocity that is based, in part, on the seed type, population input, ground speed at the row unit, spacing, and other inputs related to planting. The inputs could be inputted to, reviewed, and updated via a central processor and display, such as is disclosed in co-owned U.S. Serial No. 16/420,816, which is hereby incorporated by reference in its entirety.

Opposite the pressure side 127 of the housing 122 is the seed side 129. The seed side includes a pool or a passage for seed to be delivered to a pool for the seed meter. The housing members may comprise a rigid polymer such as plastic or the like and can be configured to reduce static energy of the components, such as by including one or more grounds. Alternatively, the disc can be manufactured from statically dissipative materials.

Positioned adjacent to and operatively connected to the seed meter housing 122 is the seed to ground system 150 and components. The components include the brush wheel and housing thereof. As will be understood, the brush wheel comprises a plurality of bristles extending from an axis that are pliable and resilient to be deformed to receive a seed to transfer the seed from the seed disc 200 to the belt 154. The housing can also be a rigid material, such as a plastic.

Attached to and extending from the brush wheel housing is the housing 156 for the belt 154. The belt housing 156 is an elongated member, comprising a rigid material, that is used to house the belt 154 and other components therein. The belt housing 156 can be unitary or multi-component, in which the components are attached to another to allow selective access to the interior thereof. An opening 158 is positioned at or near the bottom of the housing 156 to coincide with the release point wherein the seed is released from the belt and directed towards the furrow for planting.

As shown in FIG. 3, the seed meter 120 will be generally transverse to the direction of travel, as shown by the arrow 160. In addition, the release of the seed at the release or dispensing point 158 will be in a direction generally opposite that of the direction of travel (shown by the right facing arrow 162 in FIG. 3). The release of the seed will include a horizontal and vertical velocity component, wherein the horizontal velocity component is generally equal and opposite to the velocity of the row unit.

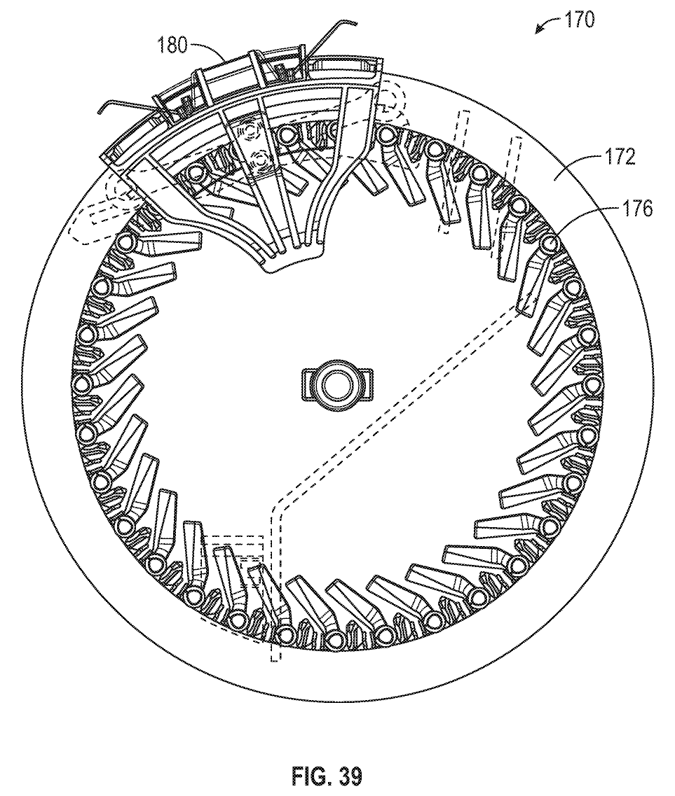

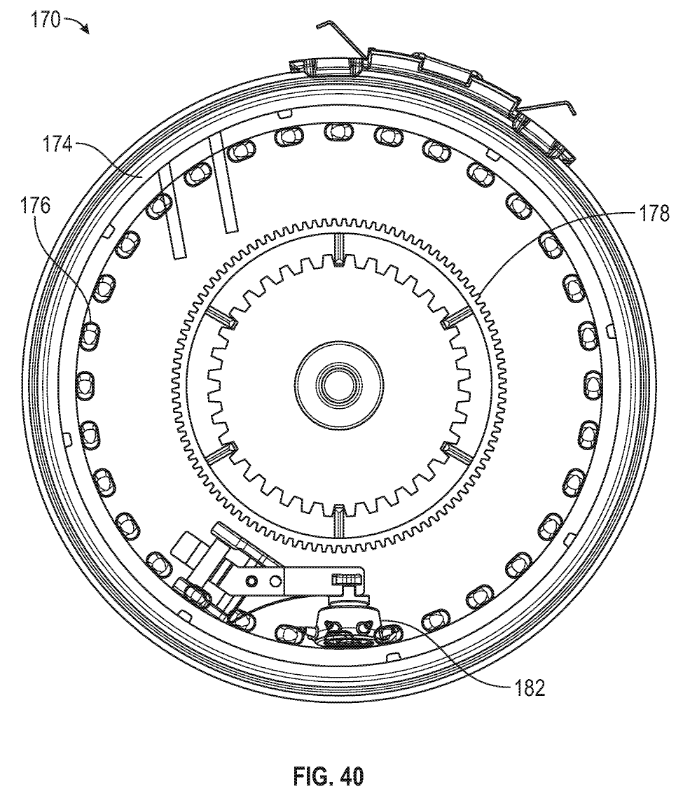

As noted, the seed meter 120 includes a seed disc 170 therein. A seed disc, as is known and shown in FIGS. 39-40, is used in conjunction with other members to meter the seeds to deliver the seeds toward the ground for planting. The seed disc is used to provide the desired number of seed with appropriate spacing. For example, some crops require a single seed to be placed in the ground and spaced an appropriate distance from subsequent seeds (e.g., corn). Other seeds can be grouped or otherwise dispensed in plural form to control the population of seed being distributed to the ground about a given area (e.g., soybeans).

The seed disc 170 includes a seed side 172 and a pressure side 174. The seeds are generally held in place at a seed cell, such as the seed cell aperture 176 shown in the figures, by a difference in pressure. This is either a positive pressure or a negative (i.e., vacuum) pressure. The seed cell aperture 176 extends from the seed side 172 to the pressure side 174. The seed cells are radially spaced and can be configured based on type of seed being planted. As seeds are generally not the ideal shape for the seed cell apertures, there is a chance that the seed may not be properly held at the aperture, or that multiple seeds may be held at a single aperture, which is not desired. Therefore, many seed meters include seed singulators 180. Seed singulators 180 are positioned at a location in the seed meter to interact with seed that is being held at a seed cell aperture (i.e., after the seed is held under pressure). The singulator is configured to interact with the seed at the seed cell aperture to mitigate plural seeds from being held at a single aperture. The seed singulators can take many shapes and forms, such as blades, brushes, fingers, or the like. Therefore, as will be appreciated, the seed disc 170 disclosed herein will aid in the operation of positioning a seed at a seed cell aperture 176 to improve planting practices.

Still additional features of the seed disc 170 include driven teeth 178 on the pressure side 174. The driven teeth 178 will interact with an output of the electric motor 126 to drive (i.e., rotate) the seed disc 170 in the meter 120. It should be noted that other types and/or configurations of driven teeth can be used and are to be considered a part of the present disclosure. In addition, a knockoff member 182 is shown in the figures. The knockoff member 182 can be used to dislodge seed held in place via the pressure difference to encourage the seed’s transport into a delivery system and towards a furrow in the ground.

As noted in the ‘072 patent, the entirety of the pressure side 174 of the seed disc in 170 in the meter 120 is under fluid pressure. This pressure can be provided by a positive pressure source (e.g., fan, blower, compressor, etc.) or a negative pressure source (e.g., vacuum). The provided pressure within the meter 120 provides a pressure differential at the seed cells 176, which holds seed at the cells as the disc 170 rotates in the meter 120. As noted, the seeds are “picked up” at a cell in the seed pool and then carried on the disc at the seed cell through the singulator and to a point of release, which may be from a brush member, knockoff member, cutoff of pressure, or some combination thereof. However, as the entire pressure side 174 is under the fluid pressure to create the pressure differential, the highest required amount of pressure is required for each seed meter of each row unit of an agricultural planting implement, such as one same as or similar to the implement 10 shown in FIG. 1. This creates an over-supplied amount of pressure to the meters, which requires a high amount of energy to produce.

Therefore, to improve the efficiency of planters, including the efficiency of pressure sources on planters, the present disclosure includes changes to a seed meter, such as shown in the seed meter 200 in the figures.

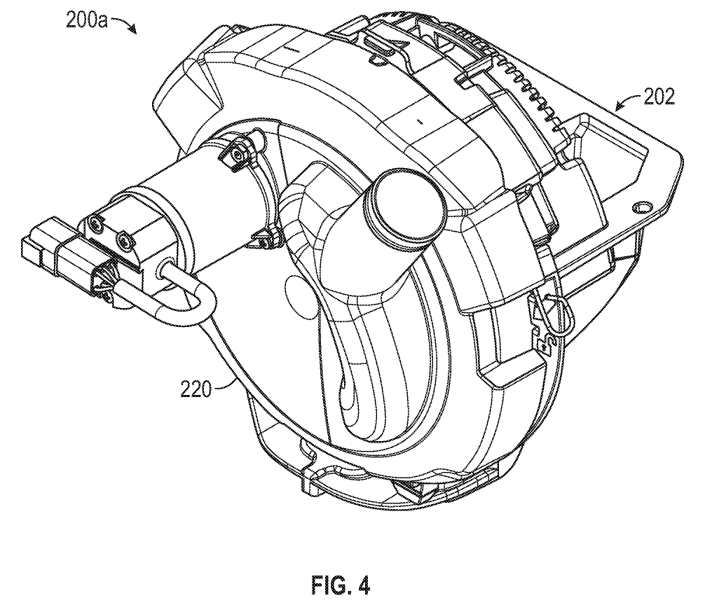

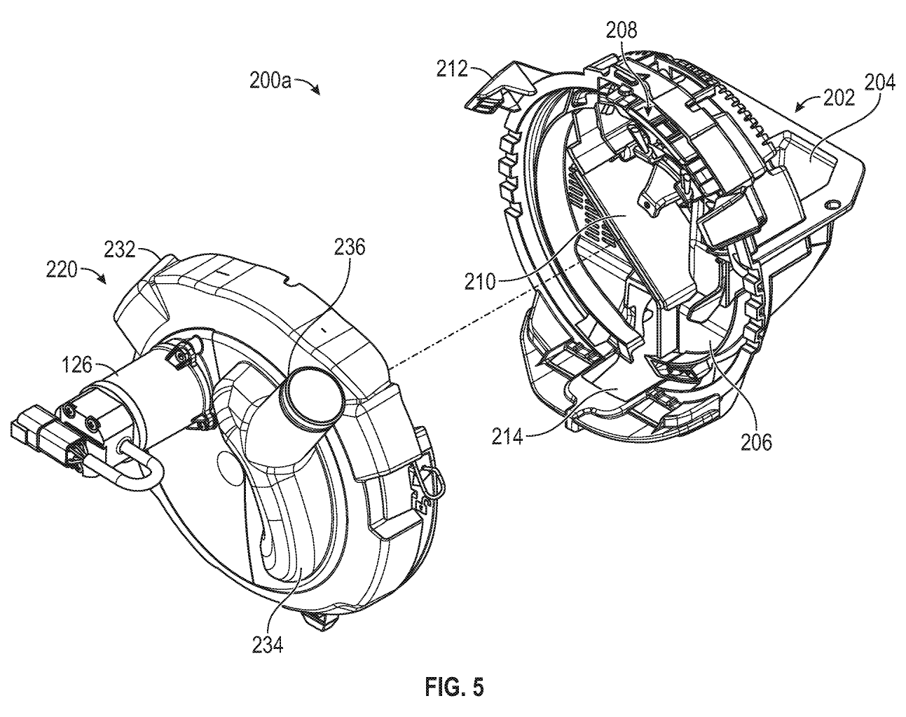

FIGS. 4-7 show embodiments of a seed meter 200 according to aspects of the disclosure, which provides for improved performance and features. As shown in 4, 6, and 7, seed meters 200a, 200b, and 200c are shown. The meters are similar to one another but do include a few differences. For example, each of the meters 200a, 200b, and 200c include a meter housing comprising a seed side member 202 and a pressure side member 220 (see, e.g., exploded view of FIG. 5). These components will be described in greater detail herein.

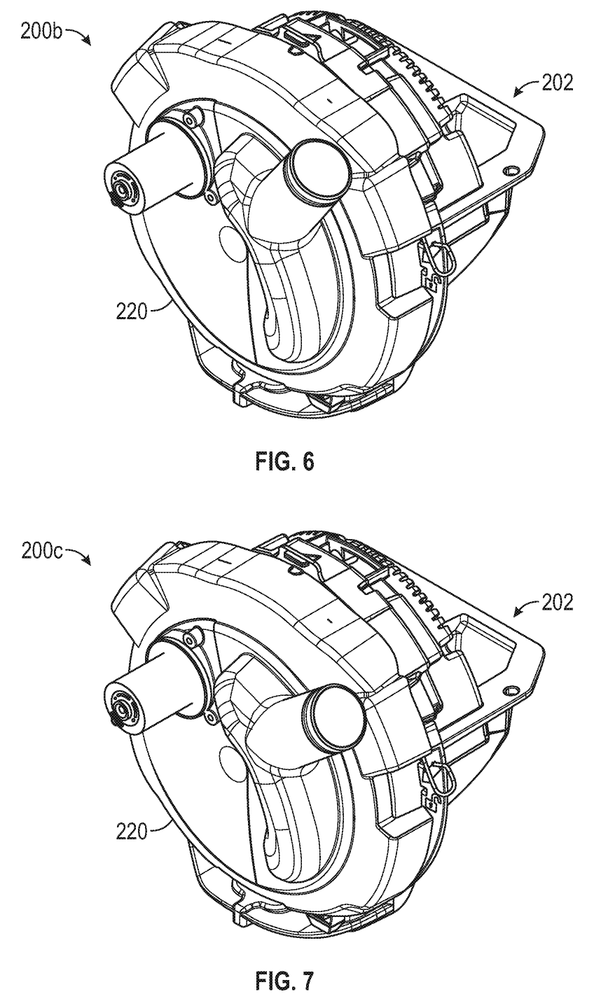

The meter 200a of FIG. 4 includes an electric motor 126 positioned on or at the pressure side member 220 of the housing. The meter 200b of FIG. 6 includes a different driver to drive a seed disc in the meter but includes a similar look for a pressure connector 236 as that of the first meter 200a. Finally, the third or bottom meter 200c shown in FIG. 7 includes a pressure connector 236 at a different angle, which shows that some differences can be included while staying within the spirit of the disclosure.

FIG. 5 is an exploded view of the first meter 200a shown in FIG. 4. As noted, the meter 200a includes a meter housing comprising a seed side member 202 and a pressure side member 220. While not shown, a seed disc, such as that shown in FIGS. 39 and 40, can be rotatably positioned in the meter 200a.

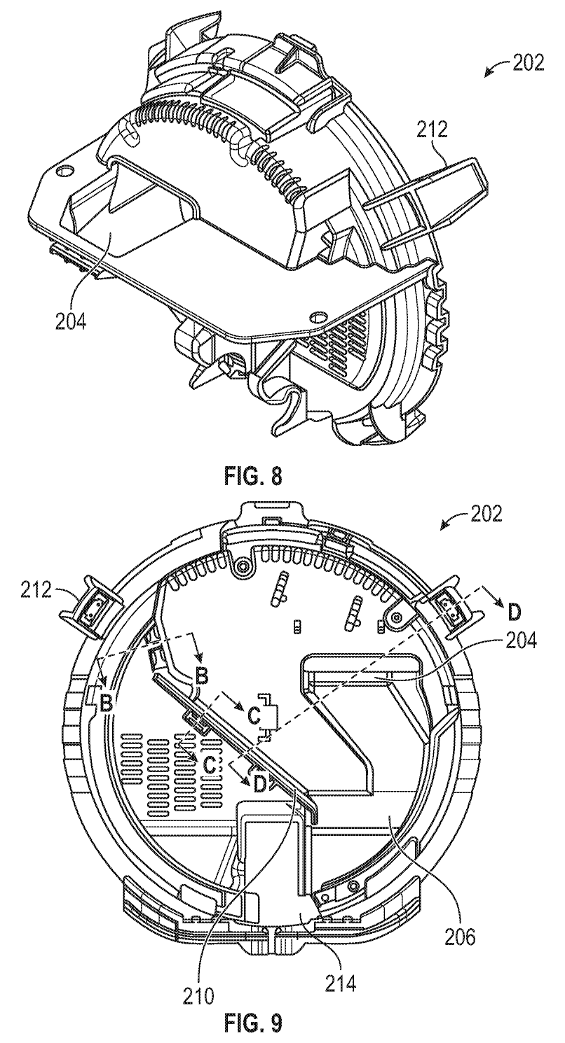

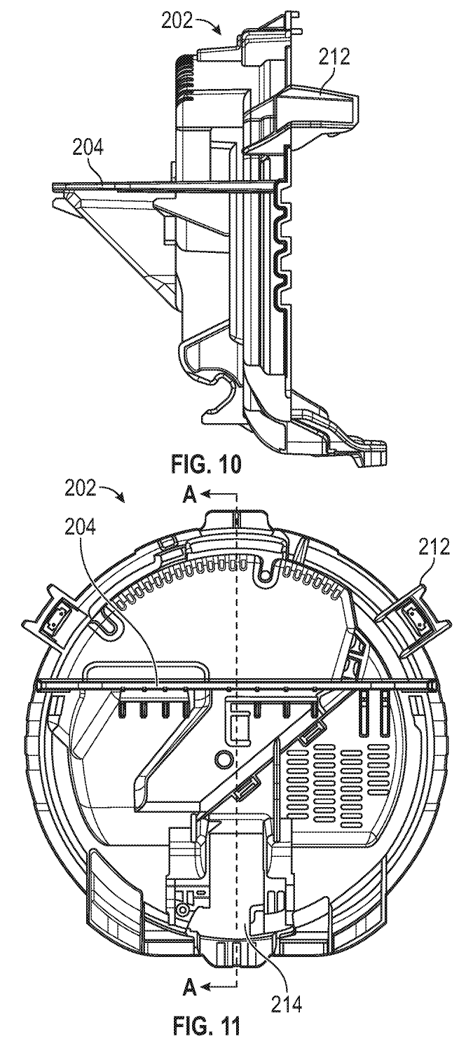

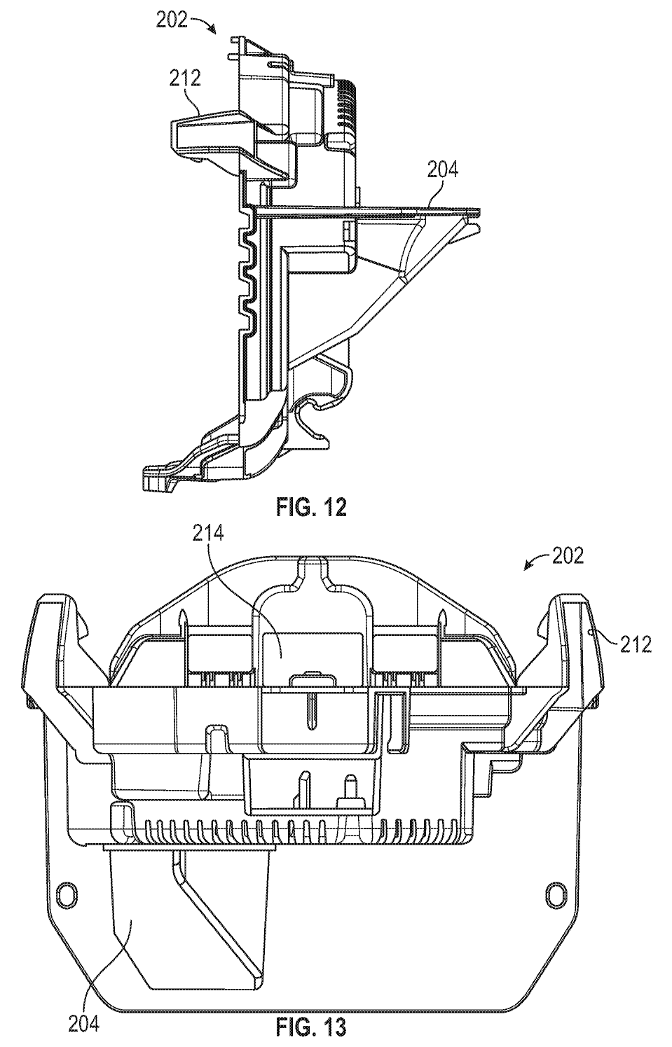

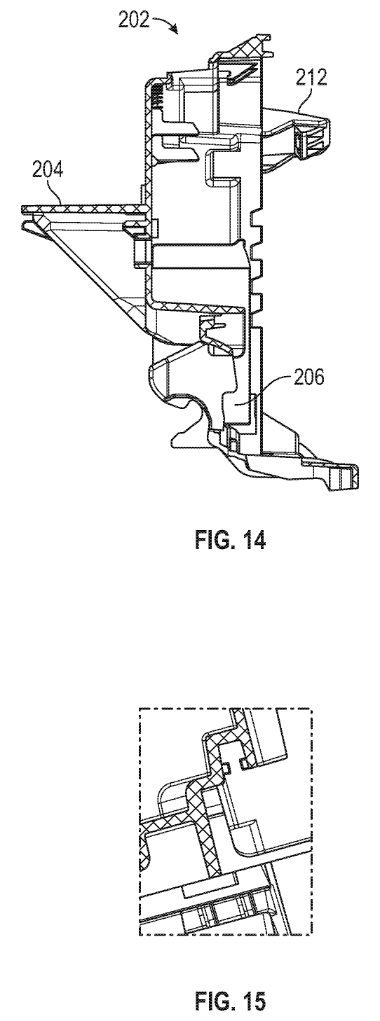

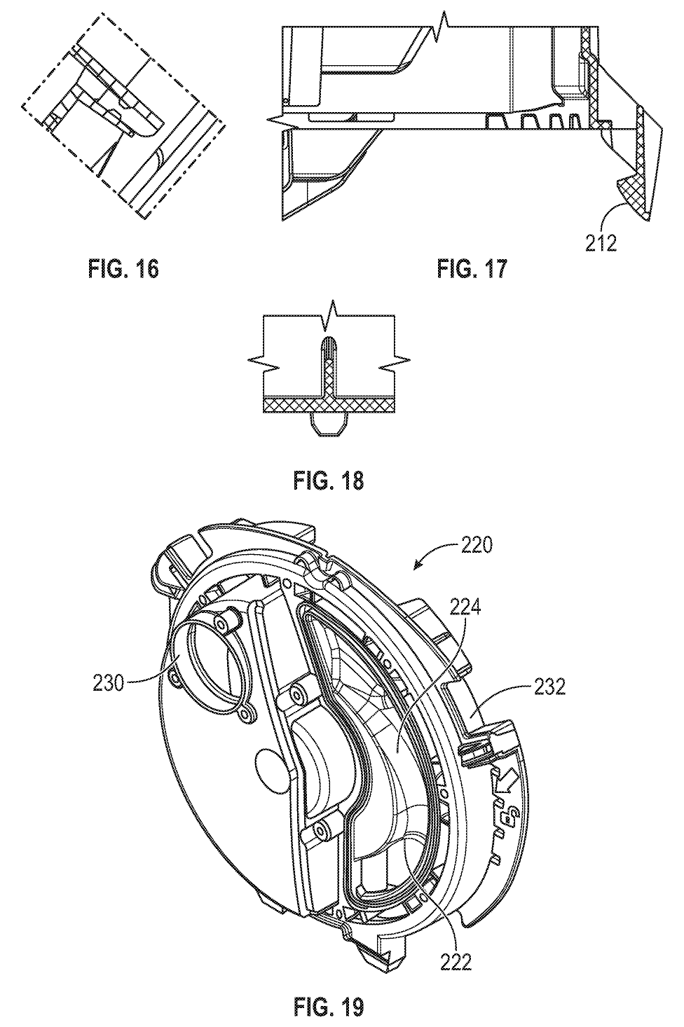

The seed side member 202 of the seed meter 200a is also shown in FIGS. 8-17 in greater detail. The following description will cover all of the figures. At an external side of the seed side member 202 is a seed entry 204. Seed or other particulate material is provided to the seed meter 200a via the seed entry 204. This can be via bulk hopper and delivery system or via on-row hoppers. The seed entry 204 directs seed to an interior portion of the seed side member 202 referred to as a seed pool. This is in part because seed is able to pool at this location. As disclosed, the rotating seed disc passes through the seed pool to agitate the seed located thereat and to urge seed to adhere to a seed cell of the seed disc. The seed pool is defined by a side wall of the seed meter housing and an internal seed side wall divider 210 extending through an interior portion of the seed side member 202. This wall divider 210 mitigates seed from improperly passing into an area where the seed is exited from the meter and towards the ground, such as via the seed delivery system 150 of FIG. 3.

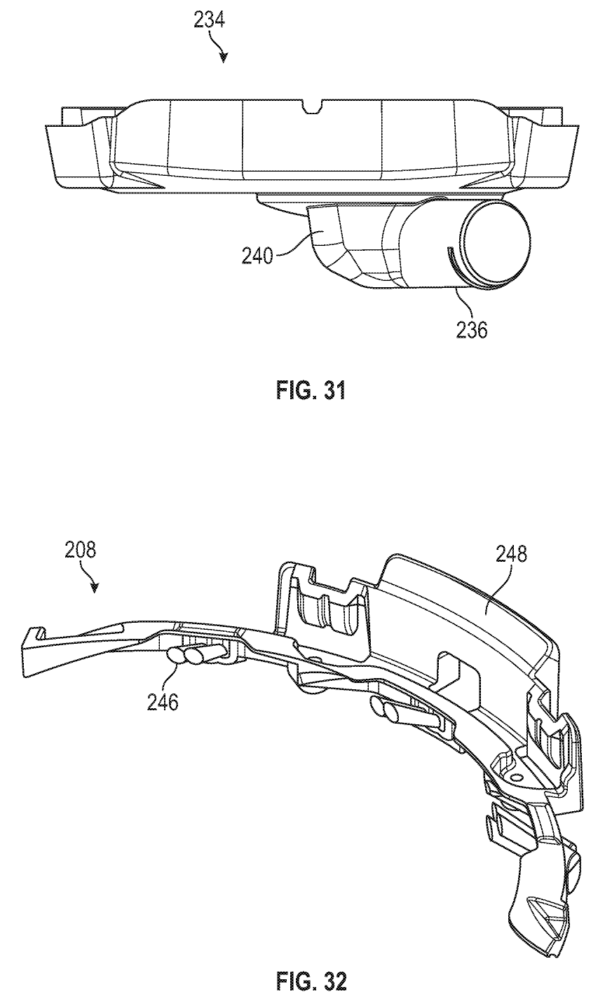

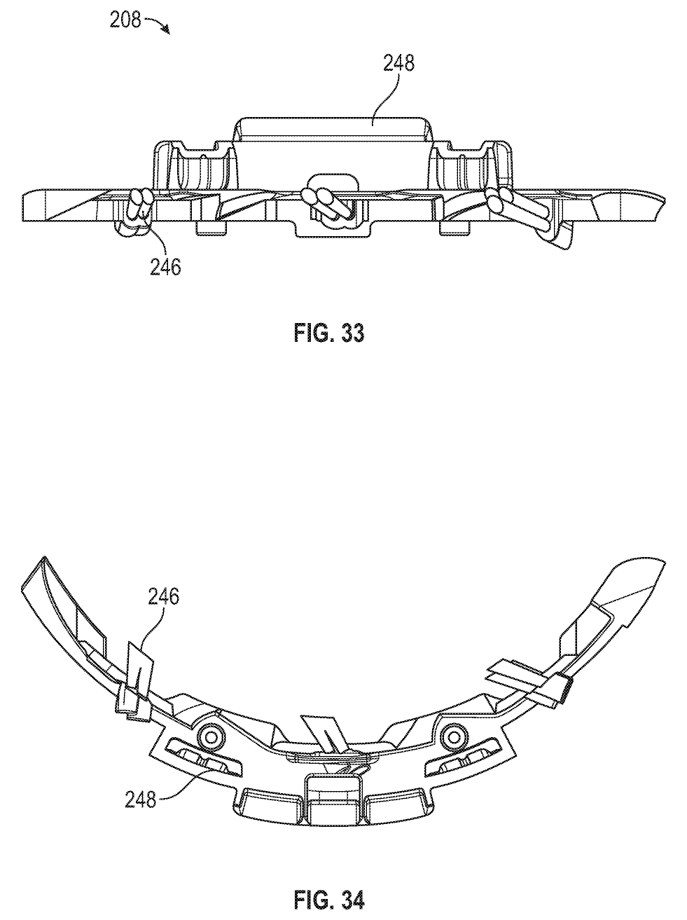

Additional components of the seed side member 202 include a singulator 208, which is shown near the 12 o’clock position of the interior of the member 202. The singulator 208, shown in detail in FIGS. 32-34 includes a housing or base portion 248. The base portion is shaped similar to the shape (i.e., circularly arched) of the seed meter housing, and is configured to be attached thereto. Extending inward from the base 248 are groups of brush members 246, which may be individual or tufts of brush material. In other embodiments, the singulator may take the form of blades or blade-like members (see, e.g., US Patent No. 9,277,688, the specification of which being incorporated by reference in its entirety). In any case, the brushes or blades are configured to interact with the seed cells and seeds adhered thereto as the seed disc rotates in the meter to attempt to mitigate excess seed being at the seed cell(s). For example, if corn is the seed, it is desirable that a single corn seed be at each cell, and the singulator used to knock off any additional corn seeds that may be at the cell. However, it should be appreciated that the singulator type not be limiting on the disclosure, and the description of which is used for aid in understanding.

Referring back to FIGS. 5 and 8-17, additional elements of the seed side member 202 include a seed exit 214 at or near the 6 o’clock position of the seed side member 202. When a delivery system 150 such as that shown in FIG. 3 is utilized, the seed exit 214 is in the form of a cutout wherein a portion of the brush wheel is able to pass into the interior of the meter housing to receive seed from the seed disc and to transport the seed to the ground. However, other types of seed meters and delivery systems include different exits. For example, the ‘688 patent discloses a meter housing with a gravity tube seed delivery system, in which the exit is a portion of a seed tube extending downward from the meter housing.

Still further, to aid in connecting the seed side member 202 to the pressure side member 220 of the meter housing, one or more connectors with hooks 212 are shown to be extending axially (i.e., in the direction of the axis of the rotating seed disc) towards the interior of the meter housing. The connectors with hooks 212 can be of any number and/or location on or about the member 202. As will be understood, the hooks 212 will interact with a wire latch 250 of the pressure side member 220 of the seed meter housing to temporarily connect the members to one another.

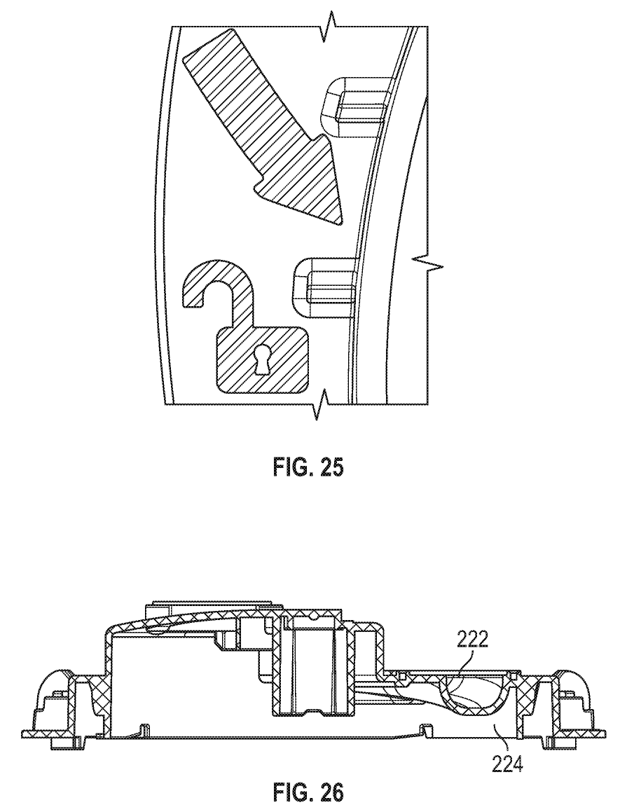

Referring now to FIGS. 19-26, the pressure side member 220 of the seed meter 200 is shown in various views and configurations. The pressure side member 220 is configured to complement and correspond to the seed side member 202, such as to be connected in a manner shown in FIGS. 4 and 5. This includes the general shape and material of the member 220 (e.g., molded plastics, polymers, metals, or other rigid materials which may also comprise anti-friction and/or anti/limited static electricity generating materials).

The pressure side member 220 is the portion of the seed meter 200 in which the fluid pressure is introduced into the interior of the seed meter to create the pressure differential at the seed cells of the rotating seed disc within the meter housing. Features, elements, and other aspects of the pressure side meter 220 are included to improve upon the entry of the fluid pressure into the interior of the meter.

For example, as shown in the figures, a fluid/air pressure compartment 222 is provided. The fluid pressure compartment is external to the interior of the meter housing (i.e., where the seed disc and seed are located) and separated from the interior of the seed meter by a wall 224. However, as is shown in the figures, the wall 224 is indented or shaped inward towards the interior of the housing at least more than the remainder of the remainder of the pressure side member 220. See, e.g., in FIG. 19, wherein the right side of the member 220 does not extend outwardly (i.e., away from the page) as much as the left side of the member 220. The left side is designated as the location where the motor inlet/aperture 230 is located, for reference.

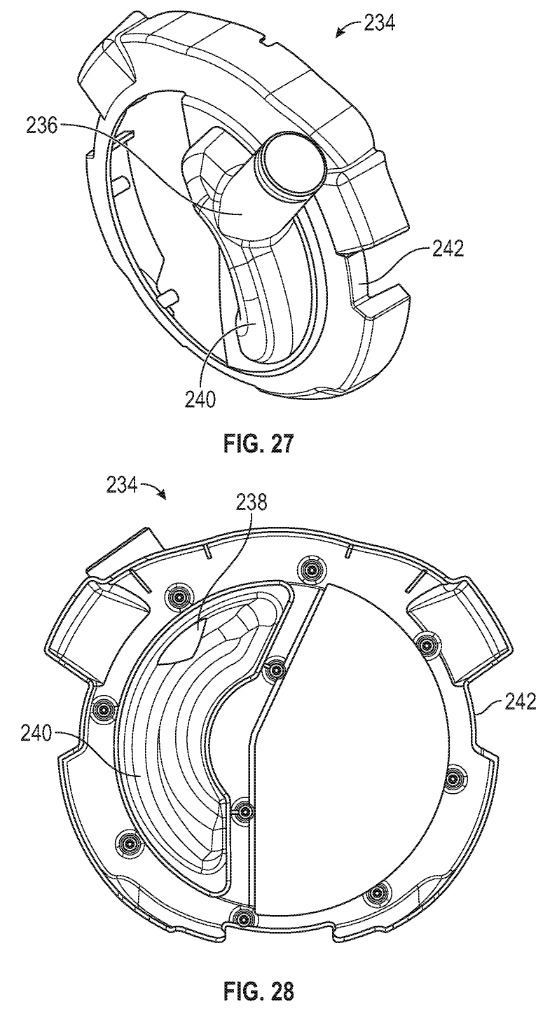

Moving to FIGS. 27-31, a cover 234 is shown. The cover 234 includes a compartment outer cover wall 240, an open portion, with both connected by an outer ring. The compartment outer cover wall 240 is configured to cover the open pressure compartment 222 to form a compartment between the outer cover wall 240 and the wall 224. Additionally, a pressure connector 236, shown to be a portion of a conduit, is shown extending from the outer cover wall 240 of the cover 234. The pressure connector 236 is configured to connect to a pressure source (not shown – either positive or negative pressure source) to provide the fluid pressure to the meter. As shown in FIG. 28, showing the interior side of the cover 234, a pressure inlet in the form of an opening is provided in line with the pressure connector 236, which allows the pressure to pass into the compartment 222 between the outer cover wall 234 and the inner wall 224 of the pressure side member 220. Therefore, the pressure is directed from a pressure source and through the connector 236 to the interior of the compartment 222.

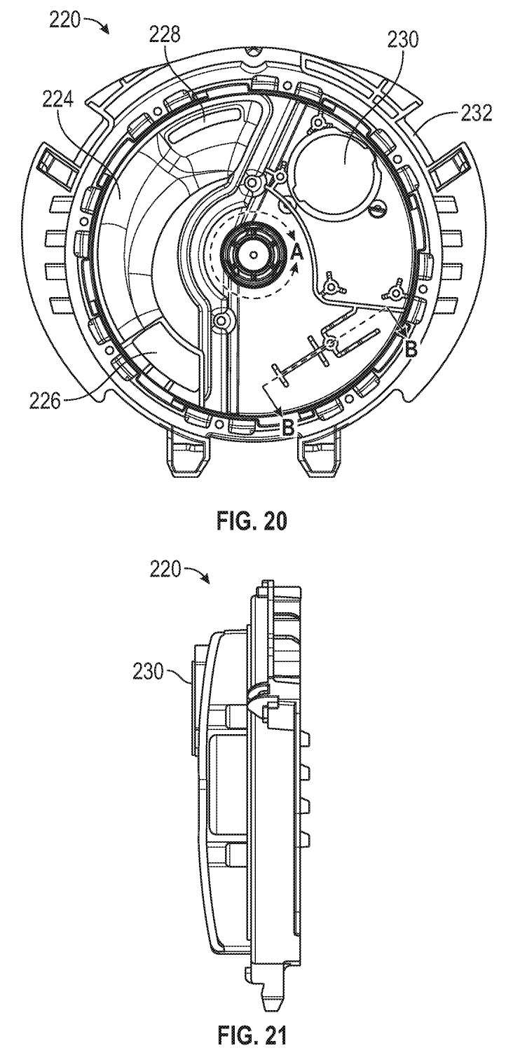

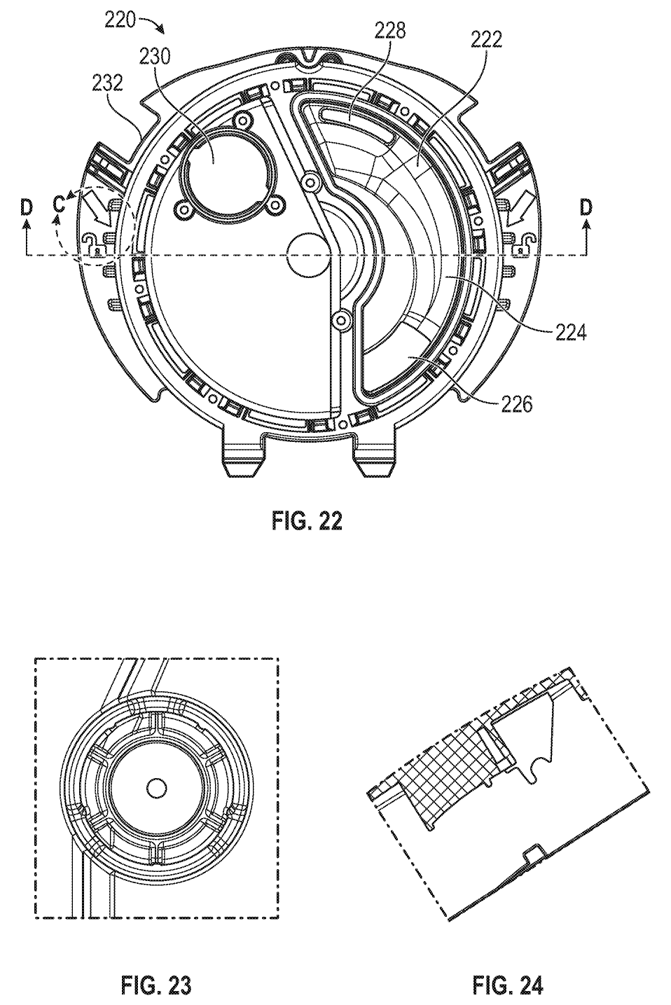

Moving back to FIGS. 20 and 22, apertures in the form of a first cutout 226 and a second cutout 228 are shown through the inner wall 224 of the compartment 222. When the seed side member 202 is connected to the pressure side member 220, the first cutout 226 aligns generally with the seed pool 206 location, while the second cutout 228 aligns generally with the location of the singulator 208 of the seed side member 202.

The pressure introduced into the pressure side member 220 via the connector 236 and into the compartment 222 is directed through the cutouts 226, 228 in the inner wall 224 to the locations of the seed pool 206 and singulator 208 first. This optimizes use of the pressure at these locations where it is key to have the highest pressure differential at the seed cells in the locations. For example, as seed is first picked up and adhered to the seed cells at the seed pool 206, it can be desired to have a higher pressure differential to ensure that seed is properly connected, as this is the start of the seed’s journey on the seed disc. Next, as there will be interaction with the singulator 208 to ensure the desired number of seed at the cell, this location is also important to ensure that the desired number of seed is not knocked off by the singulator along with the undesired seed. However, the pressure introduced via the cutouts 226, 228 will then be allowed to expand to the remainder area of the interior of the pressure side member 220, thus providing pressure at substantially all of the interior of the pressure side of the seed meter 200.

Therefore, the direction of the pressure at the cutouts 226, 228 optimizes the use of pressure added to the seed meters and allows for a lowered amount of pressure for each seed meter of a planting implement. Previously, the highest amount needed to be used to both attach and then hold the seed at the seed cells. With the compartment, cover, and cutouts of the present disclosure, the required pressure can be lowered as it is optimized at the locations of need first. This will greatly reduce the overall amount of pressure required, which reduces the energy consumption required for the planter.

Additional options and/or configurations of the components, including the cutouts, may be that the cutouts could be shaped and/or sized to act as nozzles to speed up the airflow, which can also increase the efficiencies at the cutouts and possibly even the seed meter as a whole. Still further, additional cutouts could be added if there are additional areas where the increased pressure may be desired, such as for different seed or particulate material types, planting speeds, planting volumes, or other considerations.

Still additional components, elements, and/or features of the disclosure include a motor inlet/aperture 230 in and through the pressure side member 220. As shown in FIG. 5, an electric motor 126 can be mounted at the aperture 230 with an outlet portion (i.e., a drive member, not shown) extending into the interior of the meter. This drive member can interact with a portion of the seed disc (e.g., the driven teeth 178 of FIG. 40) to “drive” the rotation of the disc via the motor 126. As noted, the motor can be an electric motor, or could be a ground driven system where pulleys, clutches, gears, belts, or the like could be used and connected to a ground driven system to provide the associated rotational velocity of the seed disc in the meter.

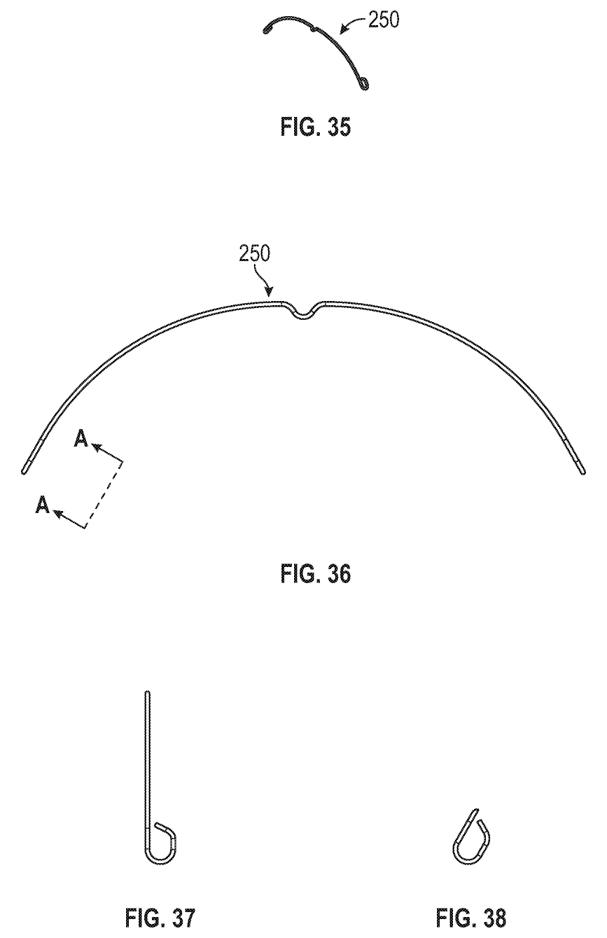

Also shown best in FIGS. 20 and 22 are notches 232 in or at an outer periphery of the pressure side member 220. The notches 232 are configured to match or otherwise be associated with the connector arms/hooks 212 of the seed side member 202. As shown in FIGS. 27-31, the cover 234 also includes notches 242 in similar locations. A wire latch 250, such as shown in FIGS. 35-38, can be positioned on or at the pressure side member 220. The wire latch 250 can be positioned at an underside of an outer peripheral lip of the pressure side member 220 (see the loop of the latch shown in FIG. 5). The wire latch 250 is biased radially outwardly, including the arms with the loops and can be held in wire holders of the pressure side member 220. At least a portion of the wire latch 250 is accessible or otherwise exposed at or near the notches 232 and 242. The hooks 212 of the connector arms of the seed side member 202 extend at least partially into the notches wherein the hooks can connect with the wire latch 250, thus holding the members to one another. To disconnect, the loops of the wire latch can be pressed generally downward to disengage with a face of the hooks, which allows the seed side member 202 and the pressure side member 220 to be separated and removed from one another, thus exposing the interior thereof. In other words, the wire is urged radially outwardly and to disengage, one or more portions of the wire is pushed radially inward to move past the snaps or hooks of the connector arms, which reduces the number of moving parts and provides a secure attachment that is easily engageable and disengaged.

Moving back to FIGS. 27-31, it is noted that the figures show the cover 234 being separate from the rest of the pressure side member 220. This includes the outer cover wall 240 with the connector 236. An outer peripheral ring extends around the wall to form a generally circular member with a large cutout therein. As shown best in FIG. 5, the cutout aligns with a portion of the pressure side member 220, such as the location of the motor inlet 230, to form a generally homogenous component with the hollow compartment 222 formed between the outer wall 240 and the inner wall 224.

However, it should also be appreciated that the cover 234 and the pressure side member 220 not be separate components and instead be a singular component with the outer wall 240 and inner wall 224 formed with the inlet 238, first cutout 226, and second cutout 228 preformed to create the hollow compartment for receiving and directing the fluid pressure into the interior of the seed meter.

Additional features and alternatives of the meter include the fluid connector 236. This can include the size of the connector, as well as the orientation of the connector for directing pressure into the interior of the meter housing. Previously, the connector would be positioned such that the inlet into the meter housing would be generally at or near a 90° angle. This angle causes disruption to the flow (i.e., create turbulent flow) of the fluid pressure into the meter, thus decreasing the efficiency and optimization of the flow of the fluid pressure.

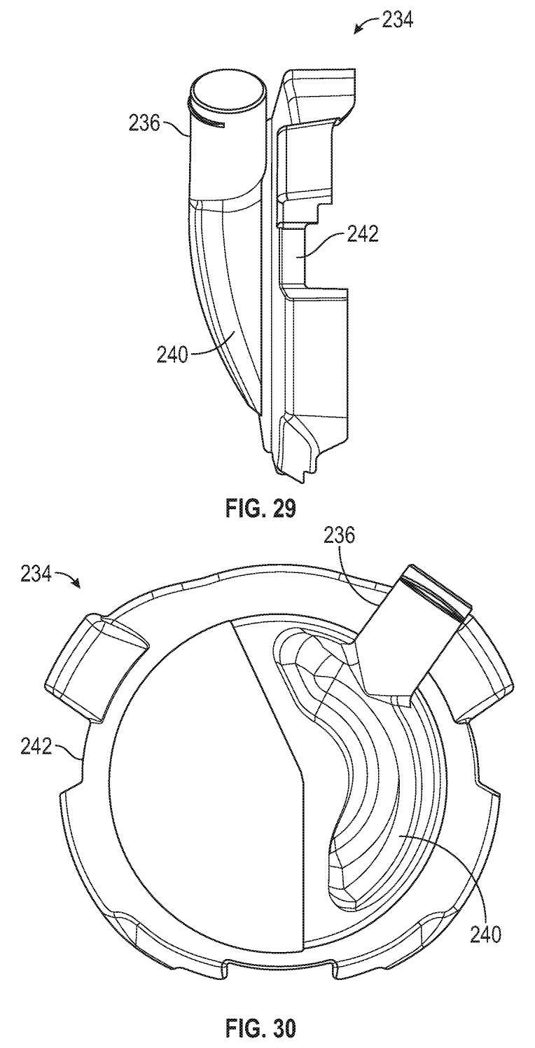

As shown best in FIG. 29, the outer wall 240 of the cover 234 is bumped out to form the compartment 222. One advantage is the creation of the compartment 222 itself, which is formed between the walls. Another advantage, as shown in FIG. 29, is that an axis of the connector is in line (at substantially 0° angle) with the inlet to the compartment. The shape of the outer wall 240 is curved to reduce the disruption of the fluid flow of the pressure as it passes through the connector into the compartment, which creates or encourages a laminar flow for the fluid.

Laminar flow the property of fluid particles in fluid dynamics to follow smooth paths in layers, with each layer moving smoothly past the adjacent layers with little or no mixing. At low velocities, the fluid tends to flow without lateral mixing, and adjacent layers slide past one another smoothly. There are no cross-currents perpendicular to the direction of flow, nor eddies or swirls of fluids. In laminar flow, the motion of the particles of the fluid is very orderly with particles close to a solid surface moving in straight lines parallel to that surface. Laminar flow is a flow regime characterized by high momentum diffusion and low momentum convection.

When a fluid is flowing through a closed channel such as a pipe or between two flat plates, either of two types of flow may occur depending on the velocity and viscosity of the fluid: laminar flow or turbulent flow. Laminar flow occurs at lower velocities, below a threshold at which the flow becomes turbulent. The threshold velocity is determined by a dimensionless parameter characterizing the flow called the Reynolds number, which also depends on the viscosity and density of the fluid and dimensions of the channel. Turbulent flow is a less orderly flow regime that is characterized by eddies or small packets of fluid particles, which result in lateral mixing. In non-scientific terms, laminar flow is smooth, while turbulent flow is rough.

Thus, the laminar flow of the flow of fluid pressure is an improvement over the turbulent flow associated with previous seed meters. It has been shown that the flow is associated with a reduction of 10-20% of fluid flow required, which can be even higher for some seed types (i.e., shapes).

Therefore, as is understood, the features of the seed meter as shown and/or described provides numerous advantages. As noted, there is a large decrease in the amount of flow required to operate the same number of seed meters on the same number of row units of planters.

It should be noted that any of the components of any of the aspects and/or embodiments provided can be combined with other components, even if not explicitly disclosed, to create yet additional embodiments that are within the scope of the present disclosure. In addition, variations and alternatives obvious to those skilled in the art are to be considered a part of the present disclosure.

1. A seed meter for an agricultural planting implement, comprising:
a seed meter housing comprising a seed side member and an air pressure side member;
wherein the air pressure side member comprises:
an air pressure inlet; and
an air pressure compartment in fluid communication with the air pressure inlet and including a wall separating the air pressure compartment from an interior of the seed meter housing, wherein the wall comprises at least one cutout through the wall to direct an air pressure into the interior of the seed meter housing.

2. The seed meter of claim 1, wherein the wall of the air pressure compartment comprises two cutouts.

3. The seed meter of claim 2, wherein a first cutout in the wall of the air pressure compartment is located at or near a seed pool location of the seed side member.

4. The seed meter of claim 2, wherein a second cutout in the wall of the air pressure compartment is located at or near a singulator of the seed meter housing.

5. The seed meter of claim 1, wherein the air pressure side member of the seed meter housing comprises a first portion comprising the wall separating the interior of the seed meter housing and a second portion covering the wall to create the air pressure compartment.

6. The seed meter of claim 5, wherein the second portion comprises the air pressure inlet.

7. The seed meter of claim 5, wherein the first and second portions are removably connected from one another.

8. The seed meter of claim 5, wherein the first portion comprises an electrical motor inlet for allowing a portion of an electric motor to extend into the interior of the seed meter housing to drive a seed disc therein.

9. The seed meter of claim 1, further comprising a seed disc rotatably mounted in the interior of the seed meter housing, and the air pressure configured to act fully on a side of the seed disc.

10. A method of providing an air pressure to a seed meter of an agricultural planting implement, the method comprising:
directing an air pressure through an inlet of an air pressure side member of the seed meter and into an air pressure compartment formed by a wall separating the air pressure compartment from an interior of the seed meter housing;
directing, via one or more cutouts in the wall separating the air pressure compartment from the interior, the air pressure first to one or more areas in the seed meter before allowing the air pressure to continue to the remaining area in the interior of the seed meter.

11. The method of claim 10, wherein the one or more cutouts comprises a first cutout at or near a seed pooling area in the seed meter.

12. The method of claim 10, wherein the one or more cutouts comprises a second cutout at or near a singulator within the seed meter.

13. The method of claim 10, wherein the air pressure is a negative pressure.

14. The method of claim 10, wherein the air pressure is applied at a plurality of seed cells of a seed disc to hold seed at the seed cells.

15. The method of claim 10, wherein the air pressure compartment is formed from the wall and an exterior portion of a cover positioned at the air pressure side member.

16. A seed meter for use with an agricultural implement, comprising:
a seed meter housing comprising a seed side member and an air pressure side member;
wherein the air pressure side member comprises:
an air pressure inlet; and
an air pressure compartment in fluid communication with the air pressure inlet and including a wall separating the air pressure compartment from an interior of the seed meter housing, wherein the wall comprises at least one cutout through the wall to direct an air pressure into the interior of the seed meter housing; and
a seed disc rotatably mounted in the seed meter housing, the seed meter comprising a plurality of radially spaced seed cells, with the air pressure directed to the seed cells to create a pressure differential to hold seed at the cells.

17. The seed meter of claim 16, further comprising a seed singulator positioned within the seed meter housing to interact with seed at the seed cells.

18. The seed meter of claim 17, wherein the wall of the air pressure compartment comprises two cutouts.

19. The seed meter of claim 17, wherein a first cutout in the wall of the air pressure compartment is located at or near a seed pool location of the seed side member.

20. The seed meter of claim 17, wherein a second cutout in the wall of the air pressure compartment is located at or near a singulator of the seed meter housing.
